(19) United States
(12) Patent Application Publication
(10) Pub. No.: US 2004/0082365 A1
(43) Pub. Date: Apr. 29, 2004

(54) Digitization and transmitting cellular RF signals by several light wavelengths

(75) Inventors: Pini Sabach, Jerusalem (IL); Arie Leizer, Shoam (IL); Paul Goldgeier, Haifa (IL); Nissim Atias, Ra'anana (IL); Yossi Azancot, Jerusalem (IL)

Correspondence Address: John N. Anastasi, Lowrie, Lando & Anastasi, LLP, One Main Street, Cambridge, MA, 02142, US

(73) Assignee: Celerica LTD, Pettach- Tikva (IL)

(21) Appl. No.: 10/623,257

(22) Filed: Jul. 18, 2003

Related U.S. Application Data
(60) Provisional application No. 60/396,597, filed on Jul. 18, 2002.

(51) Int. Cl. H04B 10/00; H04B 11/00; H04M 1/00; H04B 1/38

(52) U.S. Cl. 455/561; 379/56.1; 455/560

(57) ABSTRACT

A method and system to connect remote antennae and/or remote cellular sectors/sites to cellular base stations. The method and system described herein uses bi-directional optical wireless links, which transfer the information between the base station and the remote site, and vice versa, by single optical signal or several optical signals of different wavelengths. This method and system make it possible to place the antennae remote from the base station.

### FIELD OF THE INVENTION

The invention is directed to systems and methods for transmitting analog and digitized radio frequency (RF) signals, for example cellular signals, via optical links through the atmosphere, from a first location to a second location using either light beams of several different wavelengths or by multiplexing the signals onto a single light beam.

### BACKGROUND OF THE INVENTION

Communications networks, such as cellular telephone networks, may be formed by dividing a region into a plurality of cells and providing each cell with a base station that communicates with many mobile devices, such as cellular telephones, located within its cell. Some systems may subdivide one large cell into several smaller subcells and separate a central transceiver-antenna into a number of remote antennas that each serve one of the subcells. Such a system is described, for example, in U.S. Pat. No. 5,844,705 to Rutledge. In the Rutledge system, each remote antenna communicates with a central transceiver, located at the center of the large cell, using unguided optical radiation. Another subdivided cellular system is described in U.S. Pat. No. 6,049,593 to Acampora, wherein small picocells, interconnected by short optical links on the order of 100 meters in length, together comprise a larger cell of the system.

Other communications system may use guided or unguided optical radiation to transmit signals between parts of a network. For example, a telephone system may include a telephone exchange station that has structure, such as an electro-optic converter, which converts a signal from the telephone exchange station to an optical signal which is communicated over a free space optical link to a wireless base station. Such a system is described, for example, in U.S. Pat. No. 5,493,436 to Karasawa.

### SUMMARY OF THE INVENTION

According to one embodiment of the invention, a communication system receives and transmits a digitized signal over an optical link. The communication system comprises a first transmitter/receiver that receives a first signal, a digitizing circuit that converts the first signal into digital data, a modulating device that receives the digital data and that modulates optical components, the optical components that transmit a modulated optical signal containing the digital data and a second transmitter/receiver that comprises optical components that receive the modulated optical signal, a converter that converts the modulated optical signal to the digital data, a decoding circuit that converts the digital data to a second signal, and a transmitter that transmits the second signal to a destination.

In one example, the system may further include a first antenna, coupled to the first transmitter/receiver, that receives the first signal, and a second antenna, coupled to the second transmitter/receiver, that transmits the second signal.

In another example, the first and second transmitter/receivers may each include a telescope that focuses the optical signal. In another example, the first and second transmitter/receivers each include a plurality of telescopes, each telescope arranged to focus an optical signal having one of the predetermined wavelengths. Alternatively, the first and second transmitter/receivers may each include a telescope, the telescope having associated sets of filters and splitters to enable the telescope to transmit and receive optical signals having a plurality of the predetermined wavelengths.

In one example, the first signal may be a cellular telephone signal or any other communication signal known in the art. In addition, the first signal may comprise a plurality of cellular signals, each of the plurality of signals being associated, by the transmitter/receiver, with a corresponding optical signal having one of a plurality of predetermined wavelengths for transmission between two terminals.

According to another embodiment, a method for transmitting a digitized signal over an optical link from a source to a destination is disclosed. The method comprises acts of receiving a first signal from the source with an antenna, converting the first signal to digital data, modulating an optical signal with the digital data, and transmitting the modulated optical signal over an optical link with a transmitter. The method may further include acts of receiving the modulated optical signal containing the digital data from the optical link with a receiver, demodulating the optical signal to recover the digital data, converting the digital data into a second signal, and transmitting the second signal to the destination.

In one example, the act of transmitting the digital data includes focusing the optical signal containing the digital data with a telescope. The act of receiving the first signal may include receiving a cellular telephone signal. The act of receiving the first signal may also include receiving a plurality of signals, such as a plurality of cellular signals, and may further include deriving digital data from each of the plurality of signals and modulating an optical signal with the digital data derived from each of the plurality of signals, each optical signal having a predetermined wavelength associated with one of the plurality of signals.

In another example, the method of transmitting and receiving the signal may include acts of receiving an analog signal, modulating the optical signal with the analog signal and transmitting the modulated optical signal via a single or multi-wavelength light beams.

With the infra described arrangements, it is possible to transmit signals from one location to another with high fidelity and to support different RF technologies such as wireless local area networks (WLANs), satellite, computer networks, bluetooth or cellular technologies, such as, CDMA, TDMA, PCS, DSC, and UMTS.

### BRIEF DESCRIPTION OF THE DRAWINGS

The foregoing and other advantages of the present invention will be more fully appreciated with reference to the following drawings in which:

FIG. 1 is a block diagram of one embodiment of a system according to the invention;

FIG. 2 is a block diagram of one embodiment of a transmitter; and

FIG. 3 is a block diagram of one embodiment of a receiver.

### DESCRIPTION

According to one embodiment, the system may include two terminals, one placed, for example, near a base station, and one placed, for example, near a remote antenna/site that is to communicate with the base station. Each of these terminals may include a transmitter, a receiver and control units, such as disclosed in either of U.S. patent application No. 09/863,162, filed on May 23, 2001, and U.S. patent application No. 10/039,330 entitled “Optical Communication System” filed on Nov. 7, 2001, which are herein incorporated by reference in their entirety.

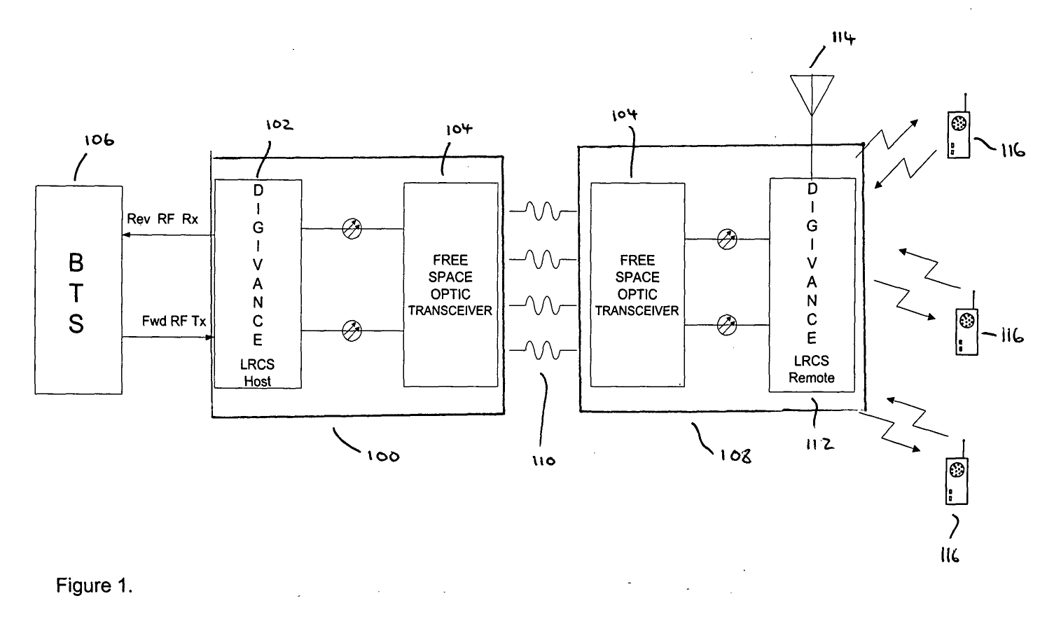

Referring to FIG. 1, there is illustrated schematically, one example of a system according to the invention. A first terminal 100 that includes communication circuitry 102, as discussed above, and an optical transceiver 104, may be coupled to a base station 106. The first terminal 100 communicates with a second terminal 108 via a free space optical link 110. The second terminal 108 also includes a optical transceiver 104 and circuitry 112, as also described below, and may be coupled to a remote antenna 114. The terminals 100, 108 may enable one-way or two-way communication between the remote antenna 114 and the base station 106. Mobile units 116 that may communicate with the remote antenna 114 may thus also communicate with the base station 106 via the terminals 100, 108 and the optical link 110.

The receiver and transmitter at each of the two terminals may be substantially identical. However, it should be understood that, for example, to comply with cellular standards, the frequencies of up and down converters within each terminal may also be different to accommodate different cellular frequencies. It should also be understood that each terminal need not have identical circuitry and functionality, for example, there may be a transmitter and receive unit at a first terminal and only a receiver unit at a second terminal. It is further to be appreciated that while two terminals are described herein for convenience, the system may operate with any number of terminals serving, for example, any number of remote antennas/sites to be coupled to a base station.

The system enables transfer of RF signals, such as cellular telephone signals, between the two terminals using optical wireless links. The infra describe systems and methods have several advantages, such as allowing a cellular base station antenna to be placed remote from the rest of the base station equipment, and to communicate with the base station equipment via a wireless optical link. In one embodiment, the cellular RF signals are digitized, using, for example, an analog to digital converter, to create a digital signal that may be transmitted via the optical links. It should be appreciated that the optical links also may carry control and status information and other information such as referenced herein. This control and status information can be used, for example, to adapt and/or control the optical signal links in response to changes in the channel and traffic conditions, and to forward and control the links from a cellular network control center. In addition, a collection of RF signals, such as from a cellular sector, may be transmitted over the optical link. For example each cellular sector, such as, for example, 3-6 sectors per cellular base station, may be assigned a different wavelength. The information for each sector may be transmitted by either slow speed links or by high speed links, with a signal source of a corresponding wavelength, such as, a single laser configured to transmit at a plurality of wavelength bands, or any number of lasers and appropriate electronics that each transmit at a wavelength band.

The electronics may comprise focussing devices that direct the optical signals to be transferred between the two terminals, such as a telescope that collimates and focuses the optical signals. According to one example, one telescope may be used per wavelength band. Alternatively, one telescope may be used per terminal, the telescope having associated filters and splitters for each predetermined wavelength of transmission, to allow operation over a number of wavelengths. It is to be appreciated that while a laser is one exemplary device that may be used to generate the optical signals, the invention is not so limited. Any appropriate light signal source such as for example, a high-power light emitting diode (LED), may be used to generate the optical signals, either alone or in combination with a laser.

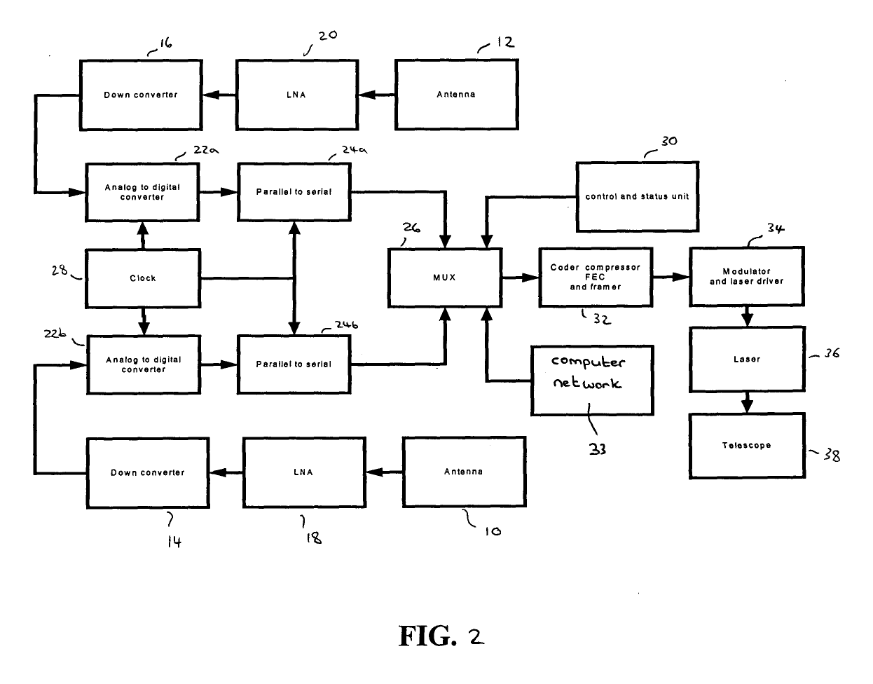

According to one exemplary embodiment, as illustrated in FIG. 2, a first terminal may comprise a transmitter that may include two antennas 10, 12, each coupled to a respective down converter 14, 16, via a low noise amplifier (LNA) 18, 20. The transmitter may further include analog-to-digital converters 22a,b, parallel-to-serial converters 24a,b, a multiplexer 26, a clock 28, and a control and status unit 30. In addition, the transmitter may include a forward error correction (FEC) and frame codec 32, a modulator and laser driver unit 34, a laser 36 and a telescope 38.

Operation of this exemplary embodiment of a transmitter will now be described. An electromagnetic signal, such as a cellular telephone signal, may be received at the first terminal by one or both of the antennas 10, 12, and may be amplified by the corresponding LNA 18, 20. The down converter 14, 16 may convert the received signal, which may be a radio frequency (RF) signal, to an intermediate frequency (IF) band signal. The analog-to-digital converter (ADC) 22a,b may convert the analog electromagnetic signal to a digital signal comprising a plurality of bits, and may typically have a parallel output. The transmitter may thus also include a parallel-to-serial converter 24a,b that may map the parallel information from the ADC output to a serial stream of bits. The mutiplexer 26 may combine several bit streams of data, received, for example, from each of the parallel-to-serial units 24a,b, to a single, possibly faster, data stream. The FEC and frame codec 32 may add additional bits to decrease the sensitivity of the information to errors, and to encapsulate the information into frames.

The control and status unit 30 may receive status information from any or all of the subsystems of the transmitter, and other equipment at the first terminal where the transmitter is located. The control and status unit 30 may control and adapt some parameters of the transmitters and/or receivers of the system in order to optimize performance. This control/adaptation may be dependent on the number of RF signals being received, the quality of the signals, etc. The control and status unit 30 also may add data to the data stream being sent, by sending data to the multiplexer. For example, the control unit may receive data from a computer network in addition to the cellular signals, and may add the data to the data stream. The multiplexer may incorporate the data into the bit stream before it reaches the FEC and frame codec 32. The bit stream is received by the modulator and laser driver 34, which modulates the laser signal according to the data to be sent. The laser signal generator thus produces an optical signal from the laser that is modulated with the digital data. The optical radiation (signal) from the laser may be directly transmitted through the telescope, or may be transmitted to the telescope via, for example, an optical fiber pig-tail, and then may be collimated by the telescope 38 and transmitted in the direction of a remote receiver.

It is to be appreciated that the above-described system can also be used, for example, to transfer data, from a plurality of sources, from the remote site to the central site. For example, a computer network 33 may be connected to the system and data from the network, from received cellular signals, from the transmitter itself may all be transferred by the system. It is also to be appreciated that although the transmitter described above includes two antennas and associated circuitry, the invention is not so limited. The system may operate with only one antenna, or with many antennas. Duplication of parts of the system, such as the antenna, LNA, ADC, etc. may be implemented to accommodate diversity requirements of typical cellular systems. Similarly, duplication may be provided in the receiver, as will be discussed in more detail infra. In exemplary systems including more than one antenna, the antennas may, but need not, be identical.

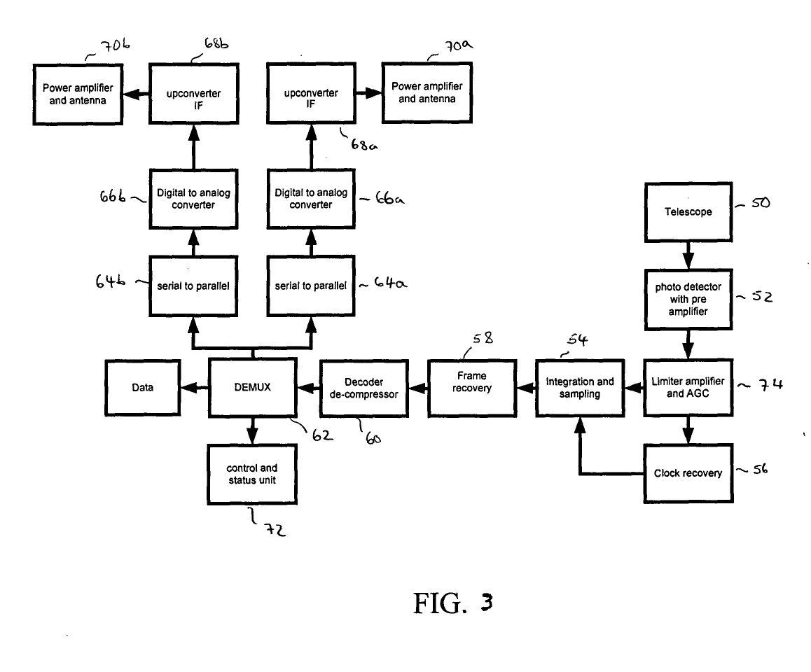

Referring to FIG. 3, there is illustrated an exemplary embodiment of a receiver that can be located at a second terminal. The receiver may include a telescope 50, a photo detector 52, an integration and sampling unit 54, a clock recovery unit 56, a frame recovery unit 58, and a decoder and de-compressor 60. The receiver may further include a de-multiplexer 62, serial-to-parallel converters 64a,b, digital-to-analog converters (DACs) 66a,b, up-converters 68a,b, and power amplifier and antenna modules 70a,b. The receiver may also include a control and status unit 72. As described above, duplication of parts of the system, such as the antenna, up-converter, DAC, etc. may be implemented to accommodate the diversity requirements of typical cellular systems.

Operation of this embodiment of the receiver will now be described. The telescope 50 may receive optical signals modulated with data and may either directly focus the optical signals onto the photo-detector 52, or may transmit the received optical signals to the photo-detector 52 via, for example, an optical fiber pig-tail. The photo-detector 52 may include photo-diodes, or any other optical-sensing devices, and may include several optical sensing devices in order to be able to detect optical signals having different wavelengths. The telescope, and associated circuitry, may direct the optical signal to an appropriate detector according to the wave-length of the optical signal. The photo-detector converts the optical radiation to an electronic signal, and the pre amplifier of the photo detector amplifies the electronic signal.

The receiver may also include a limiter amplifier and automatic gain control (AGC) unit 74 to manipulate the signal to a desired voltage level. The clock recovery unit 56 extracts timing information from the signal, which may then be used by the sampling and integration unit 54 to integrate the signal and sample it at the appropriate time. The frame recovery unit 58 builds the frame, corresponding to frames contained in the optical signals transmitted by the transmitter. Information decoding and decompression is done by the decoder and de-compressor 60. The de-multiplexer 62 may split a high speed stream of bits to a number of slower streams of bits and direct each stream of bits to a correct channel. As illustrated in FIG. 3, this exemplary receiver includes two channels, corresponding to two antennas, although it is to be understood that the system may be implemented with any number of channels. The serial-to-parallel converters 64a, 64b map serial streams of bits to parallel words. The digital-to-analog converters 66a, 66b may then convert the digital information contained in the parallel words to analog signals that may be transmitted by the respective antennas 70a, 70b. The power amplifier may amplify the analog signals as required, and the antennas may convert the amplified analog signals to electromagnetic waves, and transmit them to, for example, a cellular telephone or a base station.

In an alternative embodiment, the RF signal may be decoded at a first terminal using a generally similar method to that implemented by a mobile cellular phone when it receives an RF transmission. The decoded signal is then transmitted by the digital optical wireless communication system. On reception of the optical signal at the second terminal, a reverse process of compression and digital-to-analog conversion is performed. With this embodiment, it is to be appreciated that the RF signals (such as cellular signals) received by the terminals may be encoded, e.g., using CDMA, TDMA, GSM and any other protocol known to those of skill in the art, and may be accommodated by each terminal and the system in general. Therefore, according to this embodiment, RF signals of any communication protocol may be encoded by the transmitter circuitry before they are converted into optical signals and sent over the optical link, and may be decoded using the same communication protocol at the remote site transmitter/receiver.

It is to be appreciated that similar terminal equipment may be used to analog-modulate the optical signals with analog signals containing data to be transmitted, and transmit the optical signals between two terminals. According to one example, the RF signals may not be digitized as described above, but may be used to directly analog modulate an optical signal. In addition, as described above, a different optical wavelength may be used for each sector in a sectored system or for each cell. Thus, the analog modulated optical signals may be transmitted between the terminals over wireless optical links, using the herein described system (without, for example, the digital-to-analog, analog-to-digital and other digital processing circuitry) as described previously.

Having thus described several aspects of various embodiments of this disclosure, it is to be appreciated that various alterations, modifications and improvements may be apparent to those of skill in the art. For example, several parts of the system, such as, for example, the serial-to-parallel converters, and analog-to-digital converters, etc. have been described and illustrated as discrete components, while other parts, such as, for example, the decoder and decompressor, have been described and illustrated as combined components. However, the invention is not so limited, and any parts of the receiver and/or transmitter may be implemented as discrete electronics or components, or as part of a more complicated, single component, for example, a micro-controller, as desired. Such, and other, alterations, modifications and improvements are intended to be part of this disclosure. Accordingly, the foregoing description and figures are by way of example only and not intended to be limiting.

What is claimed is:

1. A communication system that transmits and receives a digitized signal over an optical link, the system comprising:
a first transmitter/receiver that receives a first signal and includes a digitizing circuit that converts the first signal into digital data, a modulating device that receives the digital data and that modulates optical components, and the optical components that transmit the optical signal containing the digital data;
a second transmitter/receiver including optical components that receive the optical signal, a converter that converts the optical signal to the digital data a decoding circuit that converts the digital data to a second signal, and a transmitter that transmits the second signal to a destination.

2. The system as claimed in claim 1, further including:
a first antenna, coupled to the first transmitter/receiver, that receives the first signal; and
a second antenna, coupled to the second transmitter/receiver, that transmits the second signal.

3. The system as claimed in claim 1, wherein the first and second transmitter/receivers each include a telescope that focuses the optical signal.

4. The system as claimed in claim 1, wherein the first signal is a cellular telephone signal.

5. The system as claimed in claim 1, wherein the first signal includes a plurality of signals, wherein the first transmitter receiver converts each signal to a corresponding digital signal, and wherein the modulating device modulates each corresponding digital signal with a corresponding optical signal having one of a plurality of predetermined wavelengths.

6. The system as claimed in claim 5, wherein the first and second transmitter/receivers each include a plurality of telescopes, each telescope arranged to focus an optical signal having one of the predetermined wavelengths.

7. The system as claimed in claim 5, wherein the first and second transmitter/receivers each include a telescope, the telescope having filters and splitters to enable the telescope to focus optical signals having any of the predetermined wavelengths.

9. A method for transmitting a digitized signal over an optical link from a source to a destination, the method comprising acts of:
receiving a first signal from the source with an antenna;
converting the first signal to digital data;
modulating an optical signal with the digital data;
transmitting the optical signal over an optical link with a transmitter;
receiving the optical signal containing the digital data from the optical link with a receiver;
demodulating the optical signal to recover the digital data;
converting the digital data into a second signal; and
transmitting the second signal to the destination.

10. The method as claimed in claim 9, wherein the act of transmitting the digital data includes focusing the optical signal containing the digital data with a telescope.

11. The method as claimed in claim 9, wherein the act of receiving the first signal includes receiving a cellular telephone signal.

12. The method as claimed in claim 11, wherein the act transmitting the second signal comprises providing the second signal to a base station.

13. The method as claimed in claim 9, wherein the act of receiving the first signal includes:
receiving a plurality of signals;
deriving digital data from each of the plurality of signals; and
modulating an optical signal with the digital data derived from each of the plurality of signals, each optical signal having a predetermined wavelength to be associated with each of the plurality of signals.

14. The method as claimed in claim 13, wherein the act of transmitting the optical signal comprises transmitting each optical signal with a corresponding telescope.

15. The method as claimed in claim 9, wherein the acts of transmitting the optical signal comprises splitting each optical signal and filtering each optical signal to provide an optical signal at a predetermined wavelength.
